(19) United States
(12) Patent Application Publication
(10) Pub. No.: US 2013/0282233 A1
(43) Pub. Date: Oct. 24, 2013

(54) TIRE PRESSURE MONITORING SYSTEM

(71) Applicant: Andy Hsia, Ann Arbor, MI (US)

(72) Inventor: Andy Hsia, Ann Arbor, MI (US)

(73) Assignee: FORD GLOBAL TECHNOLOGIES, LLC, DEARBORN, MI (US)

(21) Appl. No.: 13/452,966

(22) Filed: Apr. 23, 2012

(51) Int. Cl. B60C 23/04

(52) U.S. Cl. 701/36

(57) ABSTRACT

The present disclosure discloses a system and method for monitoring tire pressure. The system includes a sensor, configured to sense a tire pressure over known time intervals, and generate corresponding pressure signals. Further, a controller, connected to the sensor receives the pressure signals over the known time intervals, subsequently converting the pressure signals into a compatible format, further processing and storing the processed signals in a memory. The controller is configured to include a calculating module, which is in turn configured to calculate a rate of change of the tire pressure and display the rate of change in tire pressure through a feedback interface connected to the controller.

### BACKGROUND

This invention relates generally to tire pressure monitoring systems in vehicles, and, more particularly, towards predicting a tire pressure by sensing and calculating a rate of change in the tire pressure.

Improper tire maintenance, damage, leakage, etc., can cause a vehicle tire to develop conditions of inadequate pressure over a period. An ideal volume of air accompanied by related pressure conditions within vehicular tires is thus required for an optimal vehicle performance. Improper pressure maintained in vehicular tires can hamper the vehicle's efficiency, comfort, safety, and drivability, thereby calling for ideal tire pressures to be regulated and maintained within the tires at all times. In particular, several vehicle owners and manufacturers have observed a reduction in the vehicle's fuel efficiency when tires operate under inappropriate pressure conditions.

Owners and manufacturers thus consider conditions of tires, working under inadequate pressures, to be inappropriate and undesirable. More so, such conditions of an inappropriate tire pressure mostly go unnoticed by drivers and vehicle occupants, leading to a compromise in safety, improper fuel economy, etc.

Over the years, electronic systems have been developed and incorporated into vehicular systems that monitor tire pressure, providing regular feeds to a driver at all times. Feeds, such as the ones noted, are generally achieved through a visual display disposed over a dashboard. Such systems, however, known as tire pressure monitoring systems (TPMS), lack in providing a predictive measurement of the tire pressure over a period. Current TPMS, thus lacking in such predictive measurements, can cause the driver or an occupant to remain unaware and incapable of initiating early measures to avoid a total tire deflation, which, in particular, can result in unwanted consequences.

With no known systems existing that can predict a tire pressure, room exists for improvements that allow a driver or a vehicle occupant to learn a future tire behavior. In particular, the present disclosure aims to address and enhance a driver or an occupant's awareness of an excessive tire deflation rate.

### SUMMARY

One embodiment of the present disclosure describes a system for monitoring tire pressure. The system includes a sensor, which is configured to sense a tire pressure over known time intervals, and generate corresponding pressure signals. Further, a controller, connected to the sensor, is configured to receive the pressure signals over the known time intervals, and subsequently convert the pressure signals into a compatible format, and further process the signals, and store the processed signals in a memory. The controller, in particular, includes a calculating module, configured to calculate a rate of change of the tire pressure. A feedback interface is connected to the controller, and is configured to provide the calculated rate of change of the tire pressure.

Another embodiment of the present disclosure describes a tire pressure monitoring system including a pressure sensor, configured to sense a tire pressure over known time intervals, and generate corresponding pressure signals. The time interval are configured to be recorded through a timer, and a controller is configured to receive the pressure signals, and is configured to convert the signals into a compatible format, processing them and storing the processed signals in a memory. The controller further includes a first algorithm, installed within the memory, where the first algorithm is configured to calculate a rate of change of tire pressure based on the stored and processed pressure signals, and the time intervals. The time intervals are also configured to be stored within the memory. More so, a feedback interface is connected to the controller and is configured to display a calculated rate of change of the tire pressure.

Certain embodiments of the present disclosure describe a method of monitoring tire pressure. The method includes sensing a tire pressure over known time intervals, the sensing being carried out through a sensor, the sensor generating corresponding pressure signals. Herein, the time intervals are configured to be recorded through a timer, and stored within a memory, where the memory is configured to be stored within a controller. Further, transmitting the pressure signals to the controller converts and processes the pressure signals and stores the processed signals in the memory. More so, calculating a rate of change of tire pressure through a calculating module is enabled through the controller as well. Finally, providing the rate of change of the tire pressure is enabled through a feedback interface.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 is a schematic illustrating an exemplary tire monitoring system according to the present disclosure.

FIG. 2 is a flowchart depicting an exemplary methodology of the tire monitoring system of FIG. 1.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes systems and methods for providing a rate of change of air pressure within a vehicular tire, where the rate of change is configured to be provided through a feedback interface disposed within the vehicle. To this end, a sensor configured as a part of the stated system, senses a pressure condition existing within the tire over known time intervals. A corresponding signal is transmitted to a controller that converts and processes the incoming sensor information, referred to as the sensed condition, with both the sensed condition and the time intervals configured to be stored in the system. Calculations are subsequently performed based on the processed sensor information and the stored time intervals, and consequently, a corresponding rate of change of pressure, after the calculation, is provided.

### Exemplary Embodiments

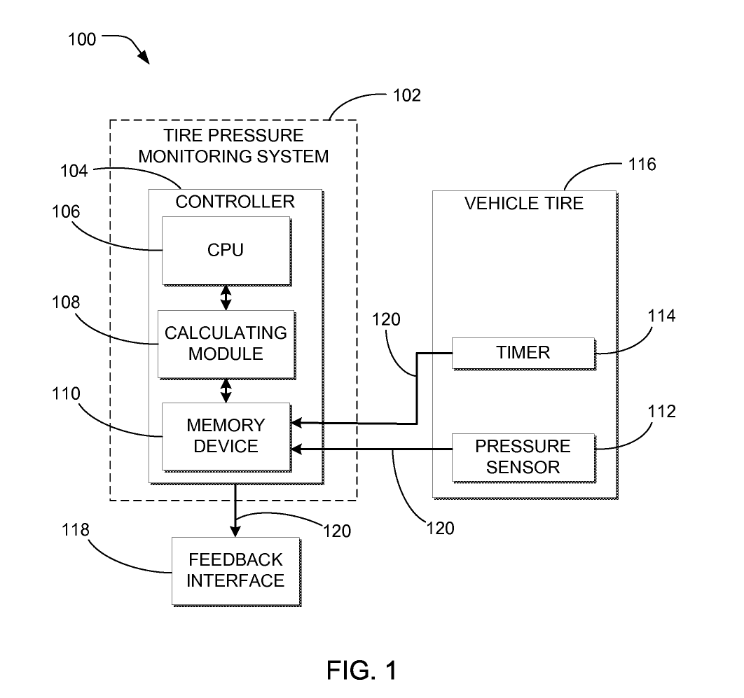

FIG. 1 illustrates an exemplary tire pressure monitoring system 100, configured to be employed in a vehicle (not shown), according to the present disclosure. The system 100 includes a group of components, namely an enclosure 102, which encloses a controller 104. The controller 104 in turn is configured to include a central processing unit (CPU) 106, a calculating module 108, and a memory, referred to as a memory device 110, as shown in the figure. Further, the stated components within the enclosure 102 are configured to interact with each other, and are adapted to be in physical contact to a vehicular tire 116 through a cabling 120, as shown. In particular, the physical contact as mentioned above, includes the memory device 110 being physically connected to a sensor, referred to as a pressure sensor 112, and a timer 114, as depicted. It is understood that all these connections too, as noted above, are enabled through the cabling 120 as well. Furthermore, a feedback interface 118 is connected to the controller 104, allowing information processed within the controller 104 to be visible to a human eye, disposed external to the system 100, as an obtained feedback. More particularly, the obtained feedback is a calculated rate of change of the tire pressure.

It is understood that the reference to the tire 116 being singular, can be applicable to all tires disposed on any land, sea, or air based vehicle. The singular reference is maintained, however, all throughout the application in order to enable ease in understanding of the aspects discussed below.

The enclosure 102, housing a set of components, as stated above, can be configured to be compact in size and dimension, sufficient enough to accommodate all the desired components in an appropriate fashion. In particular, the enclosure 102 forming a portion of the system 100 requires accommodation within vehicular confines, such that a space available can be efficiently utilized. Features such as slots or openings (not shown) in the enclosure 102 can be disposed over a surface of the enclosure 102, which can allow dissipation and transfer of heat generated within, to an outside environment. It is understood that configurations and dimensions of the enclosure 102 can be altered and changed according to vehicle specific requirements and design. Those skilled in the art will know of such alterations, features, and particularly, the manufacturing procedures to produce enclosures, such as the enclosure 102, that are capable of enclosing electrical units such as the ones already discussed.

The controller 104, disposed within the enclosure 102, forms one part of the hardware of the system 100, as depicted. As employed commonly, the controller 104 is a microprocessor based device that includes the CPU 106, enabled to process the incoming information from a known source. Further, the controller 104 may be incorporated with volatile memory units, such as a RAM and/or ROM, that functions along with associated input and output buses. The controller 104 may also be optionally configured as an application specific integrated circuit, or may be formed through other logic devices that are well known to the skilled in the art. More particularly, the controller 104 may either be formed as a portion of an externally applied electronic control unit, or may be configured as a stand-alone entity. One portion of the controller 104 is configured to be connected to the timer 114 and the sensor 112, to extract time and pressure related information, respectively, while another portion is configured to be connected to the feedback interface 118, as shown in FIG. 1. More so, signals received from the sensor 112 are configured to be stored in the memory device 110 and processed further through the CPU 106, all processing being configured within the controller 104.

Further, as disclosed before, forming a part of the controller 104, the CPU 106 may include multiple microprocessors, multiple memory modules, and multiple add-in cards (for example, graphics and/or sound card for the feedback interface 118), here on referred to as subsystems of the CPU 106. Furthermore, It will be known that two typical components, generally forming a part of the CPU 106, are the arithmetic logic unit (ALU) (not shown) and the control unit (CU) (not shown). Herein, the ALU is configured to perform arithmetic and logical operations, whereas, the control unit (CU) extracts instructions from internal memory units (including memory device 110) and decodes, processes, and executes those instructions, through the ALU when required. It is understood that the CPU 106 is primarily configured to convert incoming signals received from the sensor 112 into a compatible format and process the received signals through a first algorithm (discussed later) installed within the memory device 110.

The memory device 110, disposed within the controller 104, can include volatile and non-volatile storage regions that store information related to the overall functioning of the system 100. More particularly, the memory device 110 may accordingly record information related to the sensed air pressure existing within the tire 116, along with storing the tracked time, the tracking being performed through the timer 114. Further, the memory device 110 may also be configured to include predetermined functional values, such as maximum and minimum workable temperatures for the system 100, one or more algorithms to process converted signals, calculation methodologies, display and graphics information, maximum and minimum battery life (if included), other specifications of the system 100, memory device 110, controller 104, etc.

As noted above, the first algorithm can be a coded language, configured to be installed and stored within the memory device 110, enabled to process compatible and converted signals in calculations, with all such compatible and converted signals being received from the CPU 106. In particular, the first algorithm is configured to calculate the rate of change of tire pressure based on the stored processed signals and time intervals, the time intervals being recorded through the timer 114 and stored within the memory device 110. Further, the details of the stated signal generation, travel, reception, conversions and transmissions are discussed below.

Further, the calculating module 108, as shown, disposed within the controller 104, is configured to perform mathematical calculations related to a rate of change of pressure in the vehicle tire 116, the pressure being the air pressure maintained in the tires. As discussed earlier, the calculating module 108 utilizes processed and stored information obtained from the sensor 112, as well as the information obtained from the timer 114 to calculate a rate of change of tire pressure, the processing being carried out through the CPU. In particular, a rate of pressure change or variation is calculated by having at least two or more values of the tire pressure sensed and stored in the memory device 110. Alongside storing pressure related information, storing all time related information helps in assessing the rate of change in pressure. For example, if a time interval between successive sensing of pressure is determined to be fixed at one hour, then at least two reading of the pressure values can be performed over a one hour period. Later, more pressure readings can be obtained for subsequent one hour periods. Accordingly, if at the start of a tire pressure monitoring cycle, the pressure sensed in the tire 116 is 32 psi, and this value varies and decreases to 31.5 psi within one hour, it will be understood that the rate of change of tire pressure will be 0.5 psi/hour. Correspondingly, when such subsequent readings are noted, they form a set of values, and subsequently an average of the set can be calculated over the number of hours for which the readings have been sensed. It is understood from the above description that the first algorithm, as discussed earlier, being stored within the memory device 110, primarily functions to provide the mode of calculation of the rate of change of tire pressure.

Besides the features of the system 100, as noted above, temperature changes under certain weather conditions can cause corresponding changes in the tire pressure as well. Such changes can accordingly be termed as a ‘temperature factor’. As would be known, sensed values of tire pressure may vary considerably over a particular day, or over few days, because of changes in ambient temperatures that consequently causes a variation in a tire temperature. Moreover, other reasons or factors for a change in a tire temperature can be long drives, engine temperatures, chassis heating, or when the vehicle is driven hard over a driving course. A corresponding change thus occurring in tire pressure can be corrected by employing a calculation methodology that incorporates a temperature constant, knowing that a temperature change and a pressure change are directly proportional to each other. It will thus be known of when and by how much amount a change in pressure is caused because of a change in a tire temperature, and not particularly because of a worn-out, damaged, or a leaking tire.

Because it is understood that pressures within all employed vehicular tires, generally four in number, would vary in similar proportions to variations in ambient temperatures, pressure checks can be incorporated that can be configured to check whether a particular tire is losing or gaining pressure at a different rate than the other tires. Such differing rates of changes in pressure, when observed, can be caused because of varying engine temperatures, chassis heating, etc., which, being in addition to the ambient temperature, as mentioned above, leads to differing temperature conditions being prevalent around individual tires. Accordingly, the calculating module 108 again, can be configured to incorporate and correct all such differing rates of changes in tire pressure, caused because of differing temperature conditions around the individual tires, with all related temperature conditions being sensed through appropriately positioned temperature sensors (not shown). In addition, it will be understood that pressure checks, as noted above, can be implemented through the pressure sensor 112 (discussed later), when applied in all tires. Furthermore, in operation, when a vehicle owner starts a vehicle and activates the system 100, related changes in the tire pressure, within all employed tires, between consecutive vehicular applications or between known periods, can be made available to the owner through the feedback interface 118 (discussed later).

As discussed above, such functionalities and calculations can be configured to be provided through the calculating module 108. Accordingly, a second algorithm, based on the temperature factor, and installed in the memory device 110, can accomplish the pressure related calculations based on temperature, and accordingly be configured to calculate and correct a change in the tire pressure relative to a change in a tire temperature. In particular, the tire temperature can be sensed through a temperature sensor, as noted above, or through a set of temperature sensors (not shown), configured at different portions of the tire 116. A set of temperature sensors, as noted, can enable sensing of a temperature of the portions where they are placed around the tire 116. Correspondingly, the set of tire temperature values obtained can enable an average temperature value of the tire 116 to be calculated, enabling a final temperature value to be obtained for calculations of the tire pressure, all calculations being performed through the calculating module 108. In particular, similar calculation methodologies are known to the skilled in the art and can be accomplished through existing TPMS as well, and thus will not be discussed further.

Pressure sensor 112, as disclosed, is configured to sense tire pressure over regular or known time intervals, and can be similar to any of the widely applied pressure sensors that can sense a tire pressure. In particular, the pressure sensor 112 can be pressure transducers, pressure transmitters, piezometers, manometers, etc. Such sensors being widely known and employed in the art will not be discussed further as well.

In an embodiment, a proximity sensor can be incorporated in place of the pressure sensor 112, that, when installed at a wheel hub, can measure the distance of hub from the ground. A regular decrease in the distance, when measured, can indicate a decrease in pressure over the period.

Likewise, the timer 114 can be a digital or an analog based unit configured to sense time over certain known periods. Such periods can be varying, and can either be set as default, or they can be set according to the convenience of a user. In particular, it is understood that sensing the tire pressure and tracking the time goes hand in hand, and thus both are recorded together for enabling all possible co-relations with each other, which eventually helps in obtaining a calculated rate of change of tire pressure. This recording is configured to be stored in the memory device 110. More particularly, such devices, being widely used and applied in the art will not be discussed further.

The feedback interface 118 provides either a visual or an audible output to a user. In particular, when the output obtained is visual, perceivable images and/or digitized values to a human operator/user can be provided through a visual display disposed on a dashboard of the vehicle, the operator being a vehicle driver or an occupant. On the other hand, when the output obtained is audible, speakers installed within the vehicle can be configured to provide the audible feedback. More so, a combination of both an audible and a visual output can be configured to be provided to the operator as well. More particularly, the feedback obtained is the rate of change of tire pressure, and is configured to enable the operator to perceive a future tire behavior.

The system set out above operates to generate a rate of change in tire pressure, designed to assist drivers in predicting a tire behavior. That system operates as follows.

The system 100 can be configured to be activated either manually through a user, or the system 100 can be activated automatically upon a start of a vehicle's operation. Manual activations can be configured to be performed through buttons, knobs, touchscreens, etc., configured within an occupant's reach within the vehicle, whereas, an automatic start-up of the system 100, as stated, can be enabled right at the time of an ignition. Both the manual and automatic start-ups can enable a user to continually monitor the tire behaviour, all through the life of the vehicle. In particular, manual operations can be understood to have both activations and deactivation features of the system 100, and such can be configured in order to conserve the vehicle's battery life.

Upon an activation of the system 100, thus, the pressure sensor 112 starts sensing a tire pressure for a predefined set of time interval data. Such a set time interval data, as mentioned before, can be a default set of values, configured at the time of manufacture of the system 100, or can be configured to be varied according to a user preference. For example, a time interval data can be set for time periods of every 5 minutes, every 5 hours, every day, etc. Accordingly, the pressure sensor 112 senses the tire pressure over the said time intervals and provides the controller 104 with the correspondingly generated pressure signals for every pressure value in a set of values, as and when they are sensed. The controller 104 accordingly receives the pressure signals and configures to process and convert the signals into a compatible readable format through the CPU 106, as and when the signals are received. Once the processing and conversion is done for every sensed pressure value, the memory device 110 stores the processed values for further processing and calculations. Subsequently, when a running cycle is complete, the calculating module 108 calculates an average of the set of processed values, through the first algorithm. A final value obtained is understood to include a pressure value that is an average of all the values obtained and is relative to the time interval for which the sensing is performed. Eventually, the feedback interface 118 provides the average value calculated, to a user of the system 100, through audible means, visual means, or through a combination of the two, equipping him with an understanding of the rate of change in tire pressure over time. In particular, the final value thus obtained will provide the user of the vehicle to gauge a rate of change of tire pressure, enabling him to initiate appropriate measures before a total tire deflation.

It is understood that the system 100 can have provisions to obtain the rate of change of a tire pressure even before a running cycle is complete, and such can be manually decided and enabled by the user when interacting with the system 100. Correspondingly, the system 100 is also configured to include embodiments that include calculation of the tire pressure over known distances, or tire rotations, instead of time intervals, and such can configured to be decided by the user of the system 100 as well. It will thus be well understood that the embodiments of the calculations of the rate of change of tire pressure can be set according different factors and parameters and may not necessarily depend upon a factor of time. The embodiments of the present disclosure, therefore, do not limit the scope of the application in any way.

In addition, the system 100 can allow provisions for documenting and storing the obtained rate of change in tire pressure in the memory device 110, enabling a user to retrieve the rate of change at a later occasion. Moreover, the rate of change obtained, being documented, may also be transferable to a personal computer, hand-held electronic portable devices, smart phones, etc., and thus be accessible via personal mail or through a common server platform.

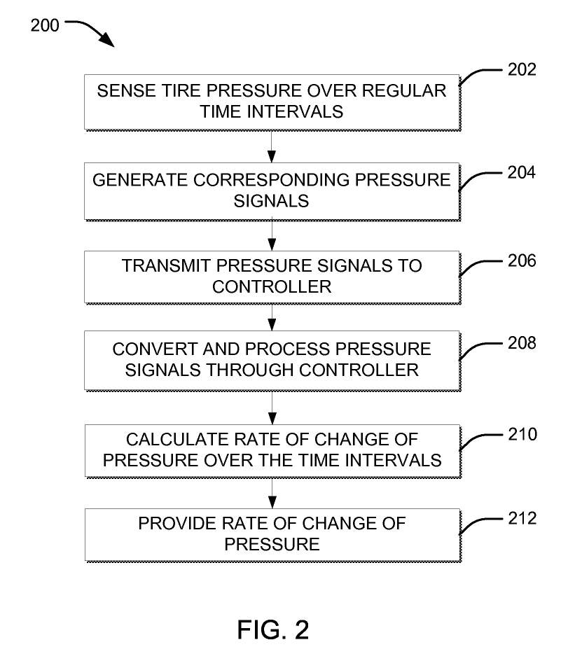

Furthermore, the aspects of the present disclosure is depicted through a flowchart in FIG. 2, and FIG. 2 illustrates an exemplary tire monitoring method 200 for obtaining a rate of change of tire pressure in accordance with the present disclosure. It is understood that the methodology presented here through the flowchart is identical to the methodology discussed in connection with FIG. 1.

Accordingly, at stage 202, upon an activation of the system 100, the pressure sensor 112 senses a pressure existing within the tire 116 in vehicle while generating a corresponding pressure signal, the generation of the signal taking place at stage 204. At stage 206, the pressure sensor 112 subsequently transmits the corresponding pressure signals to the controller 104. Further, the controller 104 configured to include the CPU 106, the calculating module 108, and the memory device 110, processes and converts the incoming pressure signals through the CPU 106, at stage 208. The CPU 106, in particular, processes the incoming pressure signal into a compatible format, to make the signals readable to the components disposed within the controller 104, all enabled within the stage 208. At stage 210, the calculating module 108 calculates an average of the pressure signals sensed over a predefined time interval, the time interval being either set by the user or set as default in the system 100. Finally at stage 212, when a calculation is complete, an average value of the pressure signals sensed is obtained and is provided to a user disposed exterior to the system 100. Such provision of the calculated value is enabled through the feedback interface 118, where the feedback interface can be enabled either through an audible format or through a visual format, or both, depending upon user requirement.

A fuel economy data can be incorporated into the rate of change of tire pressure as well, and can include a fuel economy calculation system to provide data related to fuel consumed for every change in the rate of change of tire pressure as well.

In another embodiment, the audible format or feedback can be provided to a user as a variation in loudness or sharpness in a tone as and when the system 100 detects the value of the rate of change of tire pressure to change or decrease at an alarming rate. It is understood that such detections and reading of the values of the rate of change in tire pressure will require a sensing system, apart from the one mentioned in the application.

In further embodiments, the system 100 could be configured as a portable unit or a kit, providing for an easy transfer between multiple vehicles for a set of applications.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

We claim:

1. A system for monitoring tire pressure, the system comprising:
a sensor, configured to sense a tire pressure over known time intervals, and generate corresponding pressure signals;
a controller, connected to the sensor, configured to receive the pressure signals over the known time intervals, and convert the pressure signals into a compatible format, process the signals, and store the processed signals in a memory, the controller comprising:
a calculating module, configured to calculate a rate of change of the tire pressure; and
a feedback interface, connected to the controller, configured to provide a calculated rate of change of the tire pressure.

2. The system of claim 1, wherein the sensor is a pressure sensor.

3. The system of claim 1, wherein the time interval is configured to be recorded through a timer.

4. The system of claim 1 further comprising a first algorithm installed within the memory, the first algorithm configured to calculate the rate of change of the tire pressure based on the stored processed signals and the time intervals.

5. The system of claim 4, wherein the time intervals are configured to be stored in the memory.

6. The system of claim 1 further comprising a second algorithm installed within the memory, the second algorithm configured to calculate and track a change in the tire pressure relative to a change in a tire temperature.

7. The system of claim 1, wherein the memory is configured within the controller.

8. The system of claim 1, wherein the feedback interface is enabled through one of the following:
a visual display;
an audible speaker; and
a combination of the visual display and the audible speaker.

9. A tire pressure monitoring system comprising:
a pressure sensor, configured to sense a tire pressure over known time intervals, and generate corresponding pressure signals, the time interval configured to be recorded through a timer;
a controller configured to receive the pressure signals and convert the pressure signals into a compatible format, process the signals, and store the processed signals in a memory, the memory being configured within the controller, the controller comprising:
a first algorithm, installed within the memory, the first algorithm configured to calculate a rate of change of the tire pressure based on the stored processed signals and the time intervals, the calculation being performed through a calculating module, the time intervals configured to be stored within the memory; and
a feedback interface connected to the controller configured to display a calculated rate of change of the tire pressure.

10. The system of claim 9, wherein the feedback interface is enabled through one of the following:
a visual display;
an audible speaker; and
a combination of the visual display and the audible speaker.

11. The system of claim 9 further comprising a second algorithm installed within the memory, the second algorithm configured to calculate and track a change in the tire pressure relative to a change in a tire temperature.

12. A method of monitoring tire pressure, the method comprising:
sensing a tire pressure over known time intervals, the sensing being carried out through a sensor, the sensor generating corresponding pressure signals, the time intervals configured to be recorded through a timer and stored within a memory, the memory configured to be stored within a controller;
transmitting the pressure signals to the controller, the controller configured to convert and process the pressure signals and store the processed signals in the memory;
calculating a rate of change of the tire pressure through a calculating module configured within the controller; and
providing the rate of change of the tire pressure through a feedback interface.

13. The method of claim 12, wherein the sensor is a pressure sensor.

14. The method of claim 12, wherein the memory comprises a first algorithm that calculates, through the calculating module, the rate of change of the tire pressure based on the stored processed signals and the recorded time intervals.

15. The method of claim 12, wherein the feedback interface is enabled through one of the following:
a visual display;
an audible speaker; and
a combination of the visual display and the audible speaker.

16. The method of claim 12 further comprising a second algorithm installed within the memory, the second algorithm configured to calculate and track a change in the tire pressure relative to a change in a tire temperature.
